(19) United States
(12) Patent Application Publication
(10) Pub. No.: US 2026/0030703 A1
(43) Pub. Date: Jan. 29, 2026

(54) INFORMATION PROCESSING APPARATUS, INFORMATION PROCESSING METHOD, AND NON-TRANSITORY COMPUTER READABLE MEDIUM FOR DECISION MAKING TO MAXIMIZE A PROFIT

(71) Applicant: NEC Corporation, Toyota (JP)

(72) Inventor: Kazuma SHIMIZU, Tokyo (JP)

(73) Assignee: NEC Corporation, Tokyo (JP)

(21) Appl. No.: 19/263,643

(22) Filed: Jul. 9, 2025

(30) Foreign Application Priority Data
Jul. 23, 2024 (JP) 2024-117993

(51) Int. Cl. G06Q 50/18; G06Q 30/0601

(52) U.S. Cl. CPC G06Q 50/188; G06Q 30/0601

(57) ABSTRACT

An information processing apparatus includes at least one memory storing instructions, and at least one processor configured to execute the instructions to calculate an optimum value sequence of a first quantity sequence including first quantities sequentially presented by a first user to a second user in negotiation, and an optimum value of a second quantity presented by the first user to a third user in a case where the negotiation is successful, using an objective function representing a profit or a loss of the first user in the negotiation, sequentially present optimum values of the first quantities included in the optimum value sequence of the first quantity sequence to the second user in the negotiation, and present the optimum value of the second quantity to the third user in a case where the negotiation is successful.

### INCORPORATION BY REFERENCE

This application is based upon and claims the benefit of priority from Japanese patent application No. 2024-117993, filed on Jul. 23, 2024, the disclosure of which is incorporated herein in its entirety by reference.

### TECHNICAL FIELD

The present disclosure relates to an information processing apparatus, an information processing method, and an information processing program.

### BACKGROUND ART

Techniques for making a decision in commercial transactions or the like using information processing apparatuses have been put into practical use. For example, WO 2023/100315 A1 describes a technique for determining a price that maximizes a total sales amount using a demand model representing a relationship between a sales price and a demand.

### SUMMARY

In order to make an optimum decision in a business transaction or the like, it is often necessary to consider an interest relationship among the three parties. For example, in a commercial transaction in which a first user (seller) sells a product procured from a second user (supplier) to a third user (buyer), the first user is required to (1) appropriately negotiate with the second user regarding a procurement price and a procurement amount of the product in consideration of an interest relationship with the second user, and (2) appropriately set a sales price of the product in consideration of an interest relationship with the third user. This is because the profit of the first user depends not only on the sales price and the demand of the product but also on the procurement price and the procurement amount of the product.

As described above, the technique described in WO 2023/100315 A1 maximizes a total sales amount using the demand model representing the relationship between the sales price and the demand. Therefore, even if the technique described in WO 2023/100315 A1 is applied to the above problem, appropriate negotiation with the second user regarding the procurement price and the procurement amount of the product may not be performed in consideration of the interest relationship with the second user. Therefore, the profit of the first user cannot be maximized.

The present disclosure has been made in view of the above problems, and an example object of the present disclosure is to provide a technique for making a decision to maximize a profit in consideration of an interest relationship among the three parties.

According to an example aspect of the present disclosure, an information processing apparatus includes at least one memory storing instructions, and at least one processor configured to execute the instructions to; calculate an optimum value sequence of a first quantity sequence including first quantities sequentially presented by a first user to a second user in negotiation, and an optimum value of a second quantity presented by the first user to a third user in a case where the negotiation is successful, using an objective function representing a profit or a loss of the first user in the negotiation, sequentially present optimum values of the first quantities included in the optimum value sequence of the first quantity sequence to the second user in the negotiation, present the optimum value of the second quantity to the third user in a case where the negotiation is successful.

According to another example aspect of the present disclosure, an information processing method includes a calculation process of, by a processor, calculating an optimum value sequence of a first quantity sequence including first quantities sequentially presented by a first user to a second user in negotiation, and an optimum value of a second quantity presented by the first user to a third user in a case where the negotiation is successful, using an objective function representing a profit or a loss of the first user in the negotiation, a first presentation process of sequentially presenting, by the processor, optimum values of the first quantities included in the optimum value sequence of the first quantity sequence calculated by the calculation means to the second user in the negotiation, and a second presentation process of presenting, by the processor, the optimum value of the second quantity calculated in the calculation process to the third user in a case where the negotiation is successful.

According to still another example aspect of the present disclosure, a non-transitory computer-readable medium stores a program that causes a computer to execute a calculation process of calculating an optimum value sequence of a first quantity sequence including first quantities sequentially presented by a first user to a second user in negotiation, and an optimum value of a second quantity presented by the first user to a third user in a case where the negotiation is successful, using an objective function representing a profit or a loss of the first user in the negotiation, a first presentation process of sequentially presenting optimum values of the first quantities included in the optimum value sequence of the first quantity sequence calculated in the calculation process to the second user in the negotiation, and a second presentation process of presenting the optimum value of the second quantity calculated in the calculation process to the third user in a case where the negotiation is successful.

According to an example aspect of the present disclosure, it is possible to obtain illustrative advantages that it is possible to provide a technique for making a decision to maximize a profit in consideration of an interest relationship among the three parties.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing apparatus according to the present disclosure;

FIG. 4 is a flowchart illustrating a flow of an information processing method according to the present disclosure;

FIG. 5 is a block diagram illustrating a configuration of an information processing apparatus according to the present disclosure;

FIG. 6 is a flowchart illustrating a flow of an information processing method according to the present disclosure;

FIG. 7 is a sequence diagram illustrating an operation example of the information processing apparatus according to the present disclosure;

FIG. 8 is a table illustrating an optimum value sequence of a first quantity sequence and an optimum value of a second quantity calculated in the operation example illustrated in FIG. 7;

FIG. 9 is a diagram illustrating a screen displayed on a terminal device operated by a supplier (second user) in the operation example illustrated in FIG. 7;

FIG. 10 is a diagram illustrating a screen displayed on a terminal device operated by a buyer (third user) in the operation example illustrated in FIG. 7;

FIG. 11 is a table illustrating first training data stored in a memory in the operation example illustrated in FIG. 7;

FIG. 12 is a table illustrating second training data stored in the memory in the operation example illustrated in FIG. 7; and

FIG. 13 is a block diagram illustrating a configuration of a computer that functions as an information processing apparatus according to the present disclosure.

### EXAMPLE EMBODIMENT

Hereinafter, example embodiments of the present disclosure will be described. However, the present disclosure is not limited to the example embodiments to be described below, and various modifications can be made within the scope described in the claims. For example, example embodiments obtained by appropriately combining techniques (some or all of things or methods) adopted in the following example embodiments can also be included in the scope of the present disclosure. Example embodiments obtained by appropriately omitting some of the techniques adopted in the following example embodiments can also be included in the scope of the present disclosure. Advantages mentioned in the following example embodiments are examples of advantages expected in the example embodiments, and do not define extensions of the present disclosure. That is, example embodiments that do not achieve the advantages mentioned in the following example embodiments can also be included in the scope of the present disclosure.

### First Example Embodiment

A first example embodiment that is an example embodiment of the present disclosure will be described in detail with reference to the drawings. The present example embodiment is a basic form of each example embodiment to be described below. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in the drawings referred to for describing the present example embodiment can also be employed in the other example embodiments included in the present disclosure within a range in which no particular technical problem occurs.

### (Configuration of Information Processing Apparatus)

A configuration of an information processing apparatus 1 will be described with reference to FIG. 1. FIG. 1 is a block diagram illustrating a configuration of the information processing apparatus 1.

The information processing apparatus 1 is an apparatus for performing negotiation between a first user U1 and a second user U2 from the standpoint of the first user U1. In the information processing apparatus 1, a first quantity sequence π including first quantities ω₁, ω₂, . . . , ω_{R} sequentially presented by the first user U1 to the second user U2 in the negotiation and a second quantity p presented by the first user U1 to a third user U3 in a case where the negotiation is successful are optimized collectively. Here, R is any natural number of 1 or more representing a round number of negotiations. Each first quantity ωᵣ (where r is a natural number of 1 or more and R or less) may be referred to as an “offer”, and the first quantity sequence π may be referred to as an “offer sequence”.

As an example in which the disclosure is not limited, the first user U1 may be a seller who sells a product, and the second user U2 may be a supplier who supplies a product and a buyer (customer) who buys a product from the third user U3. In this case, as an example in which the disclosure is not limited, each first quantity ωᵣ (where r is a natural number of 1 or more and R or less) may be the procurement price cᵣ of the product, the procurement amount mᵣ of the product, or a combination (cᵣ, mᵣ) of the procurement price cᵣ and procurement amount mᵣ. In this case, as an example in which the disclosure is not limited, the second quantity p can be a sales price of the product.

As illustrated in FIG. 1, the information processing apparatus 1 includes a calculation unit 11, a first presentation unit 12a, and a second presentation unit 12b.

The calculation unit 11 is a means for calculating an optimum value sequence of the first quantity sequence π (a sequence of the optimum value of each first quantity ωᵣ) and an optimum value of the second quantity p using an objective function F representing a profit or a loss of the first user U1 in the negotiation. As an example in which the disclosure is not limited, in a case where the objective function F represents a profit of the first user U1, the calculation unit 11 can be a means for calculating a value sequence of the first quantity sequence π (a sequence of values of each first quantity ωᵣ) and a value of the second quantity p that maximizes a value of the objective function F. As an example in which the disclosure is not limited, in a case where the objective function F represents a loss of the first user U1, the calculation unit 11 can be a means for calculating the value sequence of the first quantity sequence π and a value of the second quantity p that minimizes a value of the objective function F.

The first presentation unit 12a is a means for sequentially presenting the optimum value of each first quantity ωᵣ or included in the optimum value sequence of the first quantity sequence π calculated by the calculation unit 11 to the second user U2. That is, the first presentation unit 12a presents an optimum value of the first quantity ω₁ to the second user U2 in a first round of negotiation, presents an optimum value of a first quantity ω₂ to the second user U2 in a second round of negotiation, . . . , and presents an optimum value of a first quantity ω_{R} to the second user U2 in an R round of negotiation.

The second presentation unit 12b is a means for presenting an optimum value of the second quantity p calculated by the calculation unit 11 to the third user U3.

### (Flow of Information Processing Method)

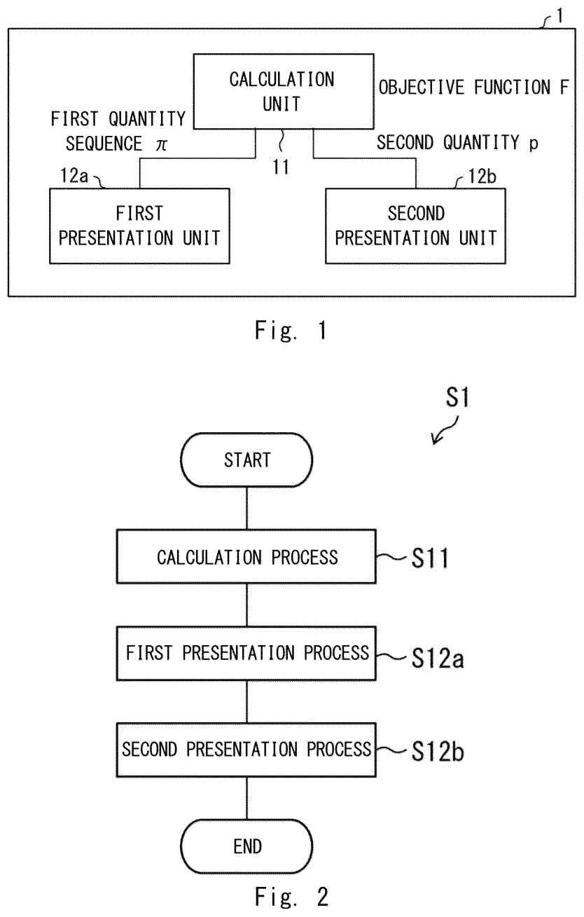

A flow of an information processing method S1 will be described with reference to FIG. 2. FIG. 2 is a flowchart illustrating a flow of an information processing method.

The information processing method S1 is a method for performing negotiation between the first user U1 and the second user U2 from the standpoint of the first user U1. In the information processing method S1, the first quantity sequence π including the first quantities ω₁, ω₂, . . . , ω_{R} sequentially presented by the first user U1 to the second user U2 in the negotiation and the second quantity p presented by the first user U1 to the third user U3 in a case where the negotiation is successful are optimized collectively.

As illustrated in FIG. 2, information processing method S1 includes a calculation process S11, a first presentation process S12a, and a second presentation process S12b. The information processing method S1 is executed by, for example, the above-described information processing apparatus 1 or a computer including a processor.

The calculation process S11 is a process of calculating an optimum value sequence of the first quantity sequence π (a sequence of the optimum values of each first quantity ωᵣ) and an optimum value of the second quantity p using the objective function F representing a profit or a loss of the first user U1 in the negotiation. As an example in which the disclosure is not limited, in a case where the objective function F represents a profit of the first user U1, the calculation process S11 can be a process of calculating a value sequence of the first quantity sequence π and the value of the second quantity p that maximizes the value of the objective function F. As an example in which the disclosure is not limited, in a a case where the objective function F represents a loss of the first user U1, the calculation process S11 can be a process of calculating a value sequence of the first quantity sequence π and the value of the second quantity p that minimizes the value of the objective function F. The calculation process S11 is executed by, for example, the calculation unit 11 of the above-described information processing apparatus 1 or a processor of a computer.

The first presentation process S12a is a process of sequentially presenting the optimum values of the first quantities or included in the optimum value sequence of the first quantity sequence π calculated in the calculation process S11 to the second user U2. That is, in the first presentation process S12a, the optimum value of the first quantity ω₁ is presented to the second user U2 in the first round of negotiation, the optimum value of the first quantity ω₂ is presented to the second user U2 in the second round of negotiation, . . . , and the optimum value of the first quantity ω_{R} is presented to the second user U2 in the R round of negotiation. The first presentation process S12a is executed by, for example, the first presentation unit 12a of the above-described information processing apparatus 1 or a processor of a computer.

The second presentation process S12b is a process of presenting the optimum value of the second quantity p calculated in the calculation process S11 to the third user U3. The second presentation process S12b is executed by, for example, the second presentation unit 12b of the information processing apparatus 1 described above or a processor of a computer.

### (Advantages of Information Processing Apparatus and Information Processing Method)

The information processing apparatus 1 can make a decision to maximize a profit (or minimize a loss) of the first user U1 in consideration of an interest relationship between the first user U1 and the second user U2 and an interest relationship between the first user U1 and the third user U3. The content of the decision-making includes determining of the first quantities ω₁, ω₂, . . . , ω_{R} to be sequentially presented to the second user by the first user U1 in the negotiation, and determining of the second quantity p to be presented to the third user by the first user U1 if the negotiation is successful. Similar advantages can be obtained according to the information processing method S1.

### Second Example Embodiment

A second example embodiment that is an example of an example embodiment of the present disclosure will be described in detail with reference to the drawings. Constituents that have the same functions as the constituents described in the above-described example embodiment are denoted by the same reference numerals, and the description of the constituents will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in each of the drawings referred to for describing the present example embodiment can be employed in the other example embodiments included in the present disclosure within a range in which no particular technical problem occurs.

### (Configuration of Information Processing Apparatus)

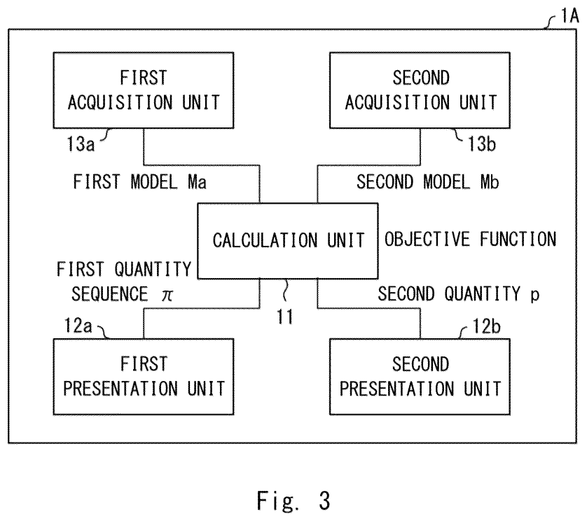

Next, a configuration of an information processing apparatus 1A will be described with reference to FIG. 3. FIG. 3 is a block diagram illustrating a configuration of the information processing apparatus 1A.

In the information processing apparatus 1A, a first acquisition unit 13a and a second acquisition unit 13b are added to the information processing apparatus 1 illustrated in FIG. 1.

The first acquisition unit 13a is a means for acquiring a first model Ma. Here, the first model Ma is a model that estimates a success probability P of negotiation from the first quantity sequence π presented by the first user U1 to the second user U2 in the negotiation. In other words, for the model, the first quantity sequence π presented by the first user U1 to the second user U2 in the negotiation is an input, and the success probability P of the negotiation is an output. The first model Ma may have time dependency. In this case, an input of the first model Ma is the first quantity sequence π presented by the first user U1 to the second user U2 in the negotiation and a time in which the negotiation is performed. Hereinafter, the success probability P output from the first model Ma in a case where the first quantity sequence π is input to the first model Ma is also referred to as a success probability P(π). If the first model Ma has time dependency, the success probability P output from the first model Ma in a case where the first quantity sequence π and a time t are input to the first model Ma is also referred to as a success probability Pₜ(π).

As an example in which the disclosure is not limited, the first model Ma may be a machine learnable model such as a neural network, a support vector machine, or a random forest. In this case, the machine learning of the first model Ma is performed in such a way that a relationship between the input π of the first model Ma and the output P(π) of the first model Ma reproduces a relationship observed in advance between the first quantity sequence π presented by the first user U1 to the second user U2 in the negotiation and the success probability P of the negotiation. If the first model Ma has time dependency, the machine learning of the first model Ma is performed in such a way that the relationship between the input π and t of the first model Ma and the output Pₜ(π) of the first model Ma reproduces a relationship observed in advance between the first quantity sequence π presented by the first user U1 to the second user U2 in the negotiation performed at the time t and the success probability P of the negotiation.

As an example in which the disclosure is not limited, the first model Ma may be a function including a parameter θ. In this case, the parameter θ is set in such a way that the relationship between the input (function argument) x of the first model Ma and the output (function value) P(π) of the first model Ma reproduces the relationship observed in advance between the first quantity sequence π presented by the first user U1 to the second user U2 in the negotiation and the success probability P of the negotiation. If the model Ma has time dependency, the parameter θ is set in such a way that the relationship between the input π and t of the first model Ma and the output Pₜ(π) of the first model Ma reproduces the relationship observed in advance between the first quantity sequence π presented by the first user U1 to the second user U2 in the negotiation performed at the time t and the success probability P of the negotiation.

The success probability P(π) for the first quantity sequence π can be decomposed into a sum of the success probability P(π, r) in each round r (P(π)=P(π, 1)+P(π, 2)+ . . . +P(π, R)). Here, the success probability P(π, r) represents a probability that the second user U2 succeeds in negotiation by accepting the first quantity ωᵣ presented by the first user U1 in the rth round. The first model Ma may be configured to output R success probabilities P(π, 1), P(π, 2), . . . , and P(π, R) for each first quantity ωᵣ included in the first quantity sequence π, instead of outputting one success probability P(π) for the first quantity sequence π.

As an example in which the disclosure is not limited, the success probability P(π, r) in each round r can be expressed as P(π, r)=p (u(ωᵣ)) using a logistic function p(π)=e^{x}/(1+e^{x}) and a utility function u(ωᵣ). If the first quantity ωᵣ is a combination of a procurement price cᵣ of a product and a procurement amount mᵣ of the product, the utility function u(ωᵣ) is given by, for example, u(ωᵣ)=(cᵣ−c₀)mᵣ+a₀ max(t+2−T, 0). Here, c₀ is a lowest procurement price at which the first user U1 can secure a profit, and a₀ is a non-negative real number. The first term of the utility function u(ωᵣ) represents sales, and the second term represents a compromise term with a sales period end. In this case, the first model Ma estimates the success probability p(u(ωᵣ)) as a function of the first quantity ωᵣ and the time t using a Gaussian process or the like.

The second acquisition unit 13b is a means for acquiring the second model Mb. Here, the second model Mb is a model that estimates a probability Q that a reaction is obtained from a third quantity D representing a reaction of the third user U3. In other words, for the model, the third quantity D representing the reaction of the third user U3 is an input and the probability Q that the reaction is obtained is an output. The second model Mb can be regarded as a function representing a probability distribution of the third quantity D (random variable). The second model Mb may be a model depending on the second quantity p presented by the first user U1 to the third user U3. In this case, the input of the second model Mb is the second quantity p presented by the first user U1 to the third user U3 and the third quantity D representing the reaction of the third user U3 to the second quantity p. The second model Mb may have time dependency. In this case, the input of the second model Mb is the time t and the third quantity D representing the reaction of the third user U3 at the time t. Hereinafter, the probability Q output from the second model Mb if the third quantity sequence D is input to the second model Mb is also referred to as a probability Q(D). If the second model Mb depends on the second quantity p, the probability Q output from the second model Mb if the second quantity p and the third quantity D are input to the second model Mb is also referred to as a probability Qₚ(D). If the second model Mb has time dependency, the probability Q output from the second model Mb if the time t and the third quantity sequence D are input to the second model Mb is also referred to as a probability Qₜ(D). If the second model Mb depends on both the time t and the second quantity p, the probability Q output from the second model Mb if the time t, the second quantity p, and the third quantity D are input to the second model Mb is also referred to as a probability Q_{t,p}(D).

As an example in which the disclosure is not limited, the second model Mb may be a machine learnable model such as a neural network, a support vector machine, or a random forest. In this case, the machine learning of the second model Mb is performed in such a way that the relationship between the input D of the second model Mb and the output Q(D) of the second model Mb reproduces the relationship observed in advance between the third quantity D representing the reaction of the third user U3 and the probability Q that the reaction is obtained. Further, if the second model Mb depends on the second quantity p, the machine learning of the second model Mb is performed in such a way that, for each second quantity p, the relationship between the inputs p and D of the second model Mb and the output Qₚ(D) of the second model Mb reproduces the relationship observed in advance between the third quantity D representing the reaction of the third user U3 and the probability Q that the reaction is obtained. If the second model Mb has time dependency, the machine learning of the second model Mb is performed in such a way that the relationship between the input D of the second model Mb and the output Qₜ(D) of the second model Mb reproduces the relationship observed in advance for each time t between the third quantity D representing the reaction of the third user U3 and the probability Q that the reaction is obtained.

As an example in which the disclosure is not limited, the second model Mb may be a function including a parameter λ. In this case, the parameter λ is set in such a way that the relationship between the input (function argument) D of the second model Mb and the output (function value) Q(D) of the second model Mb reproduces the relationship observed in advance between the third quantity D representing the reaction of the third user U3 and the probability Q that the reaction is obtained. If the second model Mb depends on the second quantity p, the machine learning of the second model Mb is performed in such a way that, for each second quantity p, the relationship between the input (function argument) D of the second model Mb and the output (function value) Qₚ(D) of the second model Mb reproduces the relationship observed in advance between the third quantity D representing the reaction of the third user U3 and the probability Q that the reaction is obtained. If the second model Mb has time dependency, the parameter λ is set in such a way that, for each time t, the relationship between the input (function argument) D of the second model Mb and the output (function value) Qₜ(D) of the second model Mb reproduces the relationship observed in advance between the third quantity D representing the reaction of the third user U3 and the probability Q that the reaction is obtained.

The calculation unit 11 of the information processing apparatus 1A calculates the values of the value sequence of the first quantity sequence π and the second quantity p that maximize or minimize the value of the objective function F as the optimum value sequence of the first quantity sequence π and the optimum value of the second quantity p, respectively, using the first model Ma acquired by the first acquisition unit 13a and the second model Mb acquired by the second acquisition unit 13b.

### (Flow of Information Processing Method)

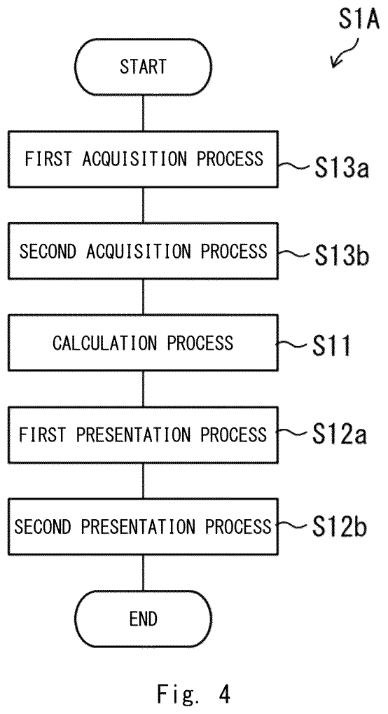

A flow of an information processing method SIA will be described with reference to FIG. 4. FIG. 4 is a flowchart illustrating a flow of the information processing method SIA.

In the information processing method SIA, a first acquisition process S13a and a second acquisition process S13b are added to the information processing method S1 illustrated in FIG. 2. The information processing method SIA is executed by, for example, the information processing apparatus 1A described above or a computer including a processor.

The first acquisition process S13a is a process of acquiring the first model Ma. As described above, the first model Ma is a model that estimates the success probability P of the negotiation from the first quantity sequence π presented by the first user U1 to the second user U2 in the negotiation. In other words, for the model, the first quantity sequence π presented by the first user U1 to the second user U2 in the negotiation is an input, and the success probability P of the negotiation is an output. The first acquisition process S13a is executed by, for example, the first acquisition unit 13a of the information processing apparatus 1A described above or the processor of the computer.

The second acquisition process S13b is a process of acquiring the second model Mb. As described above, the second model Mb is a model that estimates the probability Q that the reaction is obtained from the third quantity D representing the reaction of the third user U3. In other words, for the model, the third quantity D representing the reaction of the third user U3 is an input and the probability Q that the reaction is obtained is an output. The second acquisition process S13b is executed by, for example, the second acquisition unit 13b of the information processing apparatus 1A described above or the processor of the computer.

In the calculation process S11 of the information processing method SIA, the values of the value sequence of the first quantity sequence π and the second quantity p that maximize or minimize the value of the objective function F are calculated as the optimum value sequence of the first quantity sequence π and the optimum value of the second quantity p, respectively, using the first model Ma acquired in the first acquisition process S13a and the second model Mb acquired in the second acquisition process S13b.

The first acquisition process S13a and the second acquisition process S13b are executed in any order. After the first acquisition process S13a is executed, the second acquisition process S13b may be executed. Alternatively, after the second acquisition process S13b is executed, the first acquisition process S13a may be executed. The first acquisition process S13a and the second acquisition process S13b may be executed in parallel.

### (Advantages of Information Processing Apparatus and Information Processing Method)

According to the information processing apparatus 1A, it is possible to make a decision to maximize a profit (or to minimize a loss) of the first user U1 in consideration of the interest relationship between the first user U1 and the second user U2 and the interest relationship between the first user U1 and the third user U3. The content of the decision-making includes determining of the first quantities ω₁, ω₂, . . . , ω_{R} to be sequentially presented to the second user by the first user U1 in the negotiation, and determining of the second quantity p to be presented to the third user by the first user U1 if the negotiation is successful. Similar advantages can also be obtained according to the information processing method S1A.

Further, the information processing apparatus 1A executes the above-described decision-making using the first model Ma and the second model Mb. Accordingly, by improving the accuracy of the first model Ma and the second model Mb, it is possible to improve accuracy of the decision-making described above. Similar advantages can also be obtained according to the information processing method SIA.

### (Specific Example 1 of Objective Function)

As an example in which the disclosure is not limited, the first user U1 may be a seller who sells a product, and the second user U2 may be a supplier who supplies a product and a buyer who buys a product from the third user U3. In this case, as an example in which the disclosure is not limited, each first quantity ωᵣ is a combination (cᵣ, mᵣ) of the procurement price cᵣ of the product and the procurement amount mᵣ of the product, the second quantity p is the sales price of the product, and the third quantity D is a demand of the product.

In this case, as a first specific example in which the disclosure is not limited, the objective function F can be defined by the following Formula (1).

$$F ( p , π ) = {E}_{D} [ min ( D , m ( π ) ) p - m ( π ) c ( π ) ] P ( π ) \qquad ( 1 )$$

Here, m(π) is a procurement amount if the negotiation in which the first user U1 presents the first quantity sequence π to the second user U2 succeeds and is, for example, a procurement amount mᵣ included in the first quantity ω_{R} presented at the end of the negotiation. Further, c (π) is a procurement price if the negotiation in which the first user U1 presents the first quantity sequence π to the second user U2 is successful and is, for example, a procurement price c_{R} included in the first quantity ω_{R} presented at the end of the negotiation. P(π) is a success probability of negotiation that the first user U1 presents the first quantity sequence π to the second user U2, the success probability being estimated using the first model Ma. E_{D}[·] represents an expected value if the demand D is regarded as a random variable (more precisely, the probability variable that has the probability Q(D) or Qₚ(D) estimated using the second model Mb as a probability distribution).

On the right side of the above Formula (1), min(D, m(π)) represents a sales amount (number) of products, and p represents a sales price (unit price) of the product. Therefore, min(D, m(π))p represents a revenue of the first user U1. On the right side of the above formula (1), m (π) represents a procurement amount (number) of a product, and c (π) represents a procurement price (unit price) of the product. Therefore, m(π)c(π) represents an expenditure of the first user U1. Accordingly, E_{D}[min(D, m(π))p−m(π)c(π)] on the right side of the above formula represents an expected value of the profit of the first user U1 in a case where the negotiation is successful. Then, the entire right side of the above Formula (1) obtained by multiplying the expected value by the success probability P(π) represents the expected value of the profit of the first user U1.

As described above, the first model Ma may be configured to output the success probability P(π, r) for each first quantity ωᵣ included in the first quantity sequence π. In this case, the objective function F can be defined by the following Formula (1′).

$$F ( p , π ) = \sum \{ {E}_{D} [ min ( D , {m}_{r} ) p - {m}_{r} {c}_{r} ] P ( π , r ) \} \qquad ( {1}^{′} )$$

Here, Σ is a sum related to r. The entire right side of the above Formula (1′) represents an expected value of the profit of the first user U1, similarly to the entire right side of the above Formula (1).

### (Specific Example 2 of Objective Function)

As an example in which the disclosure is not limited, the first user U1 may be a seller who sells a product, and the second user U2 may be a supplier who supplies a product and a buyer who buys a product from the third user U3. In this case, as an example in which the disclosure is not limited, each first quantity Or may be a combination (cᵣ, mᵣ) of the procurement price cᵣ of the product and the procurement amount mᵣ of the product, the second quantity p may be a sales price of the product, the third quantity D may be a demand of the product, and the fourth quantity n may be an inventory quantity of the product.

In this case, as a second specific example in which the disclosure is not limited, the objective function F can be defined by the following Formula (2).

$$F ( p , π ) = {E}_{D} [ min ( D , n + m ( π ) ) p - m ( π ) c ( π ) ] P ( π ) \qquad ( 2 )$$

The objective function F(p, π) defined by the above Formula (2) is obtained by replacing the sales amount min(D, m (π)) in the objective function F(p, π) defined by the above Formula (1) with the sales amount min(D, n+m(π)). Therefore, the entire right side of the above Formula (2) represents an expected value of a profit of the first user U1 in consideration of an inventory quantity of the product.

As described above, the first model Ma may be configured to output the success probability P(π, r) for each first quantity ωᵣ included in the first quantity sequence π. In this case, the objective function F can be defined by the following Formula (2′). The success probability P(π, r) relevant to the first quantity ωᵣ is, as described above, a probability that the second user U2 accepts the first quantity ωᵣ presented by the first user U1 in an rth round of negotiation and the negotiation is successful.

$$F ( p , π ) = \sum \{ {E}_{D} [ min ( D , n + {m}_{r} ) p - {m}_{r} {c}_{r} ] P ( π , r ) \} \qquad ( {2}^{′} )$$

Here, Σ is a sum related to r. The entire right side of the above Formula (2′) represents an expected value of the profit of the first user U1 in consideration of the inventory quantity of the product, similarly to the entire right side of the above formula (2).

### (Specific Example 3 of Objective Function)

In the present specific example, the first user U1 negotiates with the second user U2 at time t=t1, t2, . . . , tS. Here, S is any natural number of 2 or more representing the number of negotiations. The first quantity sequence presented by the first user U1 to the second user U2 in the negotiation at the time ts (where s is a natural number of 1 or more and S or less) is written as πₜₛ, and the first quantities included in the first quantity sequence πₜₛ are written as ω_{ts;1}, ω_{ts;2}, . . . , and ω_{ts;Rts}. Here, Rₜₛ is the number of rounds of negotiation at the time ts. The second quantity presented by the first user U1 to the third user U3 if the negotiation at the time ts is successful is written as pₜₛ.

As an example in which the disclosure is not limited, the first user U1 may be a seller who sells a product, and the second user U2 may be a supplier who supplies a product and a buyer who buys a product from the third user U3. In this case, as an example in which the disclosure is not limited, each first quantity ω_{ts;r} can be a combination (c_{ts;r}, m_{ts;r}) of the procurement price c_{ts;r} at the time ts of the product and the procurement amount m_{ts;r} at the time ts of the product, the second quantity pₜₛ can be a sales price of the product at the time ts, the third quantity Dₜₛ may be a demand of the product at the time ts, and the fourth quantity nₜₛ may be an inventory quantity of the product at the time ts.

In this case, as specific example 3 in which the disclosure is not limited, the objective function F(pₜ₁, pₜ₂, . . . , p_{tS}, πₜ₁, πₜ₂, . . . , π_{tS}) can be defined by the following Formulae (3) and (4).

$${F}_{ts} ( {p}_{ts} , {π}_{ts} ) = {E}_{Dts} [ min ( {D}_{ts} , {n}_{ts} + {m}_{ts} ( {π}_{ts} ) ) {p}_{ts} - {m}_{ts} ( {π}_{ts} ) {c}_{ts} ( {π}_{ts} ) ] {P}_{ts} ( {π}_{ts} ) \qquad ( 3 )$$

$$F ( {p}_{t 1} , {p}_{t 2} , … , {p}_{tS} , {π}_{t 1} , {π}_{t 2} , … , {π}_{tS} ) = {F}_{t 1} ( {p}_{t 1} , {π}_{t 1} ) + {F}_{t 2} ( {p}_{t 2} , {π}_{t 2} ) + … + {F}_{tS} ( {p}_{tS} , {π}_{tS} ) \qquad ( 4 )$$

Here, mₜₛ(πₜₛ) is a procurement amount if the negotiation at the time ts at which the first user U1 presents the first quantity sequence πₜₛ to the second user U2 is successful and is, for example, a procurement amount m_{ts;R} included in the first quantity ω_{ts;R} presented last in the negotiation at the time ts. In addition, cₜₛ(πₜₛ) is a procurement price if the negotiation at the time ts at which the first user U1 presents the first quantity sequence πₜₛ to the second user U2 is successful and is, for example, a procurement price c_{R;ts} included in the first quantity ω_{ts;R} presented last in the negotiation at the time ts. In addition, Pₜₛ(πₜₛ) is a success probability of negotiation at the time ts at which the first user U1 presents the first quantity sequence πₜₛ to the second user U2, the success probability being estimated using a time-dependent first model Ma. In addition, E_{Dts}[·] represents an expected value if the demand Dₜₛ is regarded as a random variable (more precisely, a probability variable that has the probability Qₜₛ(D) or Q_{ts,p}(D) estimated using the second model Mb as a probability distribution). The inventory quantity nₜₛ at the time ts is calculated using an initial inventory quantity nu at the time t1 and a recurrence formula nₜₛ=max (nₜₛ₋₁+mₜₛ₋₁−Dₜₛ₋₁, 0).

On the right side of the above Formula (3), min(Dₜₛ, nₜₛ+mₜₛ(πₜₛ)) represents the sales amount (number) of products at the time ts, and pₜₛ represents a sales price (unit price) of the product at the time ts. Therefore, min(Dₜₛ, nₜₛ+mₜₛ(πₜₛ))pₜₛ represents a revenue of the first user U1 at the time ts in consideration of the inventory quantity of the product. On the right side of the above Formula (3), mₜₛ(πₜₛ) represents a procurement amount (number) of products at the time ts, and cₜₛ(πₜₛ) represents a procurement price (unit price) of the product at the time ts. Therefore, mₜₛ(πₜₛ)cₜₛ(πₜₛ) represents an expenditure of the first user U1 at the time ts. Accordingly, E_{Dts}[min(Dₜₛ, nₜₛ+mₜₛ(πₜₛ))pₜₛ−mₜₛ(πₜₛ)cₜₛ(πₜₛ)] on the right side of the above formula represents an expected value of the profit of the first user U1 in consideration of the inventory quantity of the product in a case where the negotiation at the time ts is successful. Then, the entire right side of the above Formula (3) obtained by multiplying the expected value by the success probability Pₜₛ(πₜₛ) represents an expected value of the profit of the first user U1 at the time ts in consideration of the inventory quantity of the product. Accordingly, the right side of the above Formula (4) represents a sum of the expected values of the profits of the first user U1 at the times t1, t2, . . . , ts in consideration of the inventory quantity of the product.

As described above, the first model Ma may be configured to output a success probability Pₜₛ(πₜₛ, r) for each first quantity ω_{ts;r} included in the first quantity sequence πₜₛ. In this case, a function Fₜₛ(pₜₛ, πₜₛ) representing the expected value of the profit of the first user U1 at the time ts can be defined by the following Formula (3′). The success probability Pₜₛ(πₜₛ, r) relevant to the first quantity ωᵣ is a probability that the second user U2 succeeds in negotiation by accepting the first quantity ωᵣ presented by the first user U1 in the rth round of negotiation at the time ts.

$${F}_{ts} ( {p}_{ts} , {π}_{ts} ) = \sum \{ {E}_{Dts} [ min ( {D}_{ts} , {n}_{ts} + {m}_{ts ; r} ) {p}_{ts} - {m}_{ts ; r} {c}_{ts ; r} ] {P}_{ts} ( {π}_{ts} , r ) \} \qquad ( {3}^{′} )$$

Here, Σ is a sum related to r. The entire right side of the above Formula (3′) represents an expected value of the profit of the first user U1 at the time ts, similarly to the entire right side of the above Formula (3).

### Third Example Embodiment

A third example embodiment that is an example embodiment of the present disclosure will be described in detail with reference to the drawings. Constituents that have the same functions as the constituents described in the above-described example embodiment are denoted by the same reference numerals, and the description of the constituents will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in each of the drawings referred to for describing the present example embodiment can be employed in the other example embodiments included in the present disclosure within a range in which no particular technical problem occurs.

### (Configuration of Information Processing Apparatus)

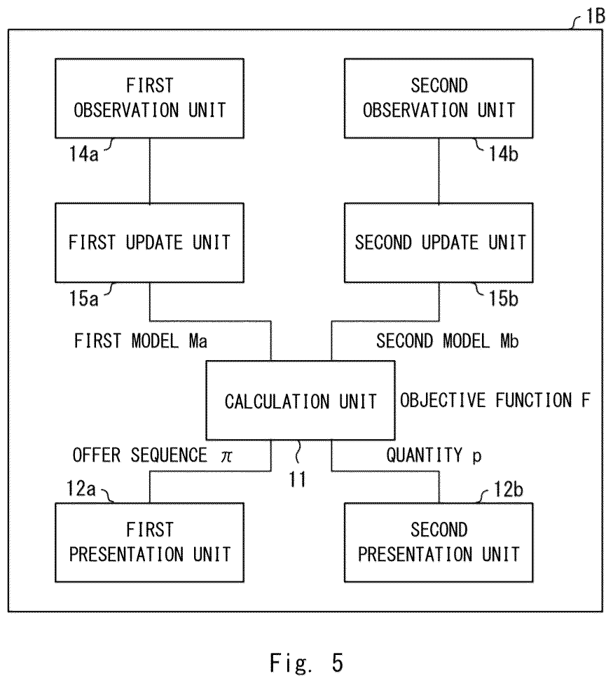

A configuration of an information processing apparatus 1B will be described with reference to FIG. 5. FIG. 5 is a block diagram illustrating a configuration of the information processing apparatus 1B.

In the information processing apparatus 1B, a first observation unit 14a, a second observation unit 14b, a first update unit 15a, and a second update unit 15b are added to the information processing apparatus 1 illustrated in FIG. 1.

The first observation unit 14a is a means for observing the success or failure of negotiation in which the first user U1 presents an optimum value sequence of the first quantity sequence π calculated by the calculation unit 11 to the second user U2. The first observation unit 14a provides the first update unit 15a with the first training data D1 obtained by combining the optimum value sequence of the first quantity sequence π calculated by the calculation unit 11 and the success or failure of the observed negotiation.

The second observation unit 14b is a means for observing a value of the third quantity D obtained if the first user presents the optimum value of the second quantity p calculated by the calculation unit 11 to the third user. The second observation unit 14b provides the second update unit 15b with the second training data D2 obtained by combining an optimum value of the second quantity p calculated by the calculation unit 11 and the observed value of the third quantity D. The optimum value of the second quantity p is necessary if a model depending on the second quantity p is used as the second model Mb. Accordingly, if a model that does not depend on the second quantity p is used as the second model Mb, training data including only the observation values of the third quantity D may be used.

The first update unit 15a is configured to update the first model Ma described in the second example embodiment using the first training data D1 acquired from the first observation unit 14a. The first model Ma may be updated using one piece of first training data D1 obtained in one negotiation or may be updated using a data set including a plurality of pieces of first training data D1 obtained in two or more negotiations.

The second update unit 15b is configured to update the second model Mb described in the second example embodiment using the second training data D2 acquired from the second observation unit 14b. The second model Mb may be updated using one piece of second training data D2 obtained in one negotiation or may be updated using a data set including a plurality of pieces of second training data D2 obtained in two or more negotiations.

The calculation unit 11 of the information processing apparatus 1B calculates values of a value sequence of the first quantity sequence π and the second quantity p that maximize or minimize the value of the objective function F as the optimum value sequence of the first quantity sequence π and the optimum value of the second quantity p, respectively, using the first model Ma updated by the first update unit 15a and the second model Mb updated by the second update unit 15b.

### (Flow of Information Processing Method)

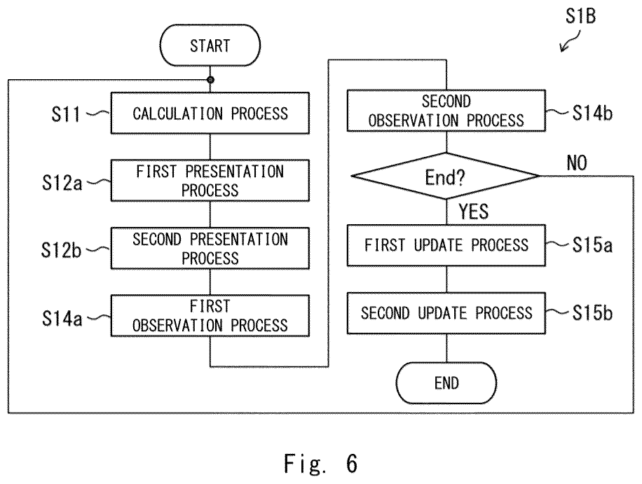

A flow of an information processing method SIB will be described with reference to FIG. 6. FIG. 6 is a flowchart illustrating a flow of the information processing method S1B.

In the information processing method S1B, a first observation process S14a, a second observation process S14b, a first update process S15a, and a second update process S15b are added to the information processing method S1 illustrated in FIG. 2. The information processing method SB is executed by, for example, the information processing apparatus 1B illustrated in FIG. 5 or a computer including a processor.

In the information processing method S1B, the calculation process S11, the first presentation process S12a, the second presentation process S12b, the first observation process S14a, and the second observation process S14b are repeatedly executed until a predetermined end condition is satisfied. Thereafter, the first update process S15a and the second update process S15b are executed.

The first observation process S14a is a process of observing the success or failure of negotiation in which the first user U1 presents the optimum value sequence of the first quantity sequence π calculated in the calculation process S11 to the second user U2. The first training data D1 obtained by combining the optimum value sequence of the first quantity sequence π calculated in the calculation process S11 and the success or failure of the negotiation observed in the first observation process S14a is accumulated in, for example, a memory (not illustrated). The first observation process S14a is executed by, for example, the first observation unit 14a of the information processing apparatus 1B illustrated in FIG. 5 or the processor of the computer.

The second observation process S14b is a process of observing the value of the third quantity D obtained if the first user presents the optimum value of the second quantity p calculated in the calculation process S11 to the third user. The second training data D2 obtained by combining the optimum value of the second quantity p calculated in the calculation process S11 and the value of the third quantity D observed in the second observation process S14b is accumulated in, for example, a memory (not illustrated). The optimum value of the second quantity p is necessary if a model depending on the second quantity p is used as the second model Mb. Accordingly, if a model that does not depend on the second quantity p is used as the second model Mb, training data including only the observation values of the third quantity D may be used. The second observation process S14b is executed by, for example, the second observation unit 14b of the information processing apparatus 1B illustrated in FIG. 5 or the processor of the computer.

The first update process S15a is a process of updating the first model Ma described in the second example embodiment using the first training data D1 accumulated in the memory (not illustrated) until the predetermined end condition is satisfied. The first update process S15a is executed by, for example, the first update unit 15a of the information processing apparatus 1B illustrated in FIG. 5 or the processor of the computer.

The second update process S15b is a process of updating the second model Mb described in the second example embodiment using the second training data D2 accumulated in the memory until the predetermined end condition is satisfied. The second update process S15b is executed by, for example, the second update unit 15b of the information processing apparatus 1B illustrated in FIG. 5 or the processor of the computer.

The first update process S15a and the second update process S15b are executed in any order. After the first update process S15a is executed, the second update process S15b may be executed. After the second update process S15b is executed, the first update process S15a may be executed. The first update process S15a and the second update process S15b may be executed in parallel.

The information processing method SIB is repeatedly performed. In the calculation process S11 included in the information processing method S1B executed at an nth time, the first model Ma and the second model Mb updated by the first update process S15a and the second update process S15b included in the information processing method SIB executed at an n−1th time are used.

### (Advantages of Information Processing Apparatus and Information Processing Method)

The information processing apparatus 1B makes a decision to maximize a profit (or minimize a loss) of the first user U1 in consideration of the interest relationship between the first user U1 and the second user U2 and the interest relationship between the first user U1 and the third user U3. The content of the decision-making includes determining of the first quantities ω₁, ω₂, . . . , ω_{R} to be sequentially presented to the second user by the first user U1 in the negotiation, and determining of the second quantity p to be presented to the third user by the first user U1 if the negotiation is successful. Similar advantages can be obtained according to the information processing method S1B.

Further, the information processing apparatus 1B can update the first model Ma and the second model Mb used for the above-described decision-making in order to improve accuracy of the first model Ma and the second model Mb used for the above-described decision-making. Accordingly, it is possible to improve the accuracy of the above-described decision-making. Similar advantages can be obtained according to the information processing method S1B.

### (Operation Example of Information Processing Apparatus)

As an example in which the disclosure is not limited, the first user U1 may be a seller who sells a product, and the second user U2 may be a supplier who supplies a product and a buyer who buys a product from the third user U3. In this case, as an example in which the disclosure is not limited, each first quantity Or may be a combination (cᵣ, mᵣ) of the procurement price cᵣ of the product and the procurement amount mᵣ of the product, the second quantity p may be a sales price of the product, and the third quantity D may be a demand of the product.

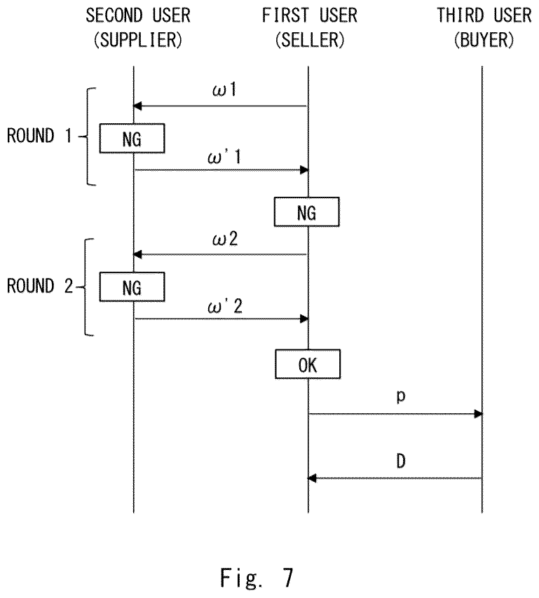

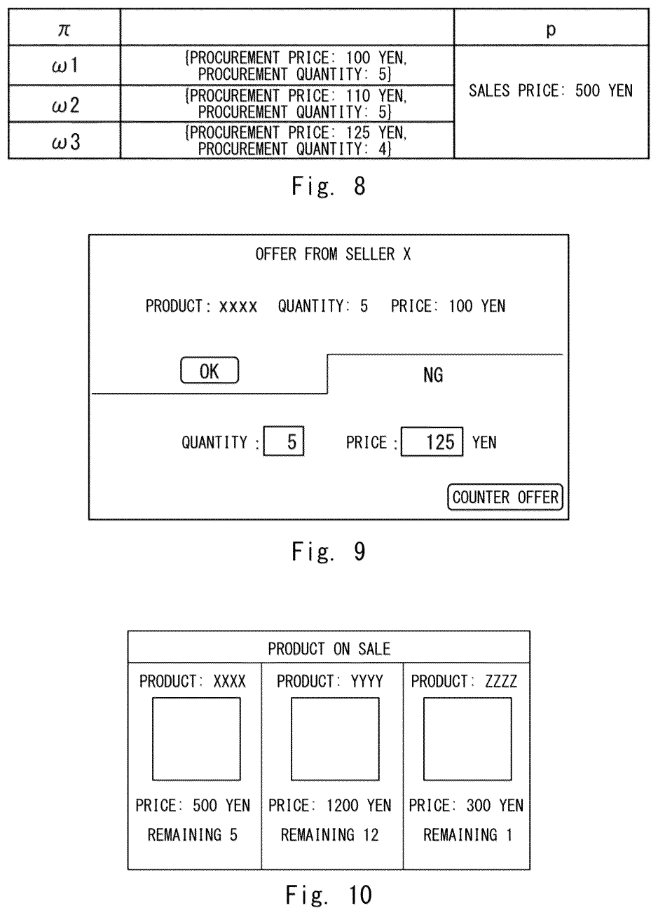

An operation example of the information processing apparatus 1B that can be implemented in this case will be described with reference to FIG. 7. FIG. 7 is a sequence diagram illustrating an operation example of the information processing apparatus 1B. In the following description, FIGS. 8 to 12 are appropriately referred to.

First, the information processing apparatus 1B calculates the optimum value sequence of the first quantity sequence π and the optimum value of the second quantity p. In the operation example illustrated in FIG. 7, the optimum value sequence of the first quantity sequence π and the optimum value of the second quantity p are calculated as illustrated in FIG. 8.

Subsequently, the information processing apparatus 1B presents the first quantity ω1={procurement price: 100 yen, procurement quantity: 5} as an offer to the supplier in the first round of negotiation. In the operation example illustrated in FIG. 7, it is assumed that a supplier who has rejected this offer presents a counter offer ω′1={procurement price: 125 yen, procurement quantity: 5} to the seller.

The first quantity ω1={procurement price: 100 yen, procurement quantity: 5} is presented to the supplier using, for example, a screen displayed on a terminal device operated by the supplier. FIG. 9 illustrates an example of a screen displayed on the terminal device operated by the supplier. A counter offer can also be input by the supplier on the screen illustrated in FIG. 9.

Next, the information processing apparatus 1B determines whether a counter offer ω′1 from the supplier is accepted. Any algorithm for the determination is used. However, for example, an algorithm for accepting the counter offer w′1 from the supplier if the counter offer ω′1 is more favorable than the first quantity ω2={procurement price: 110 yen, procurement quantity: 5} to be offered next and reject the counter offer ω′1 otherwise is conceivable. In the operation example illustrated in FIG. 7, since the counter offer ω′1 is worse than the first quantity ω2={procurement price: 110 yen, procurement quantity: 5} to be offered next, the information processing apparatus 1B rejects the counter offer ω′1.

Subsequently, the information processing apparatus 1B presents the first quantity ω2={procurement price: 110 yen, procurement quantity: 5} as an offer to the supplier in the second round of negotiation. In the operation example illustrated in FIG. 7, it is assumed that the supplier who has rejected this offer presents a counter offer ω′2={Procurement price: 120 yen, procurement quantity: 4} to the seller.

Next, the information processing apparatus 1B determines whether a counter offer ω′2 from the supplier is accepted. In the operation example illustrated in FIG. 7, since the counter offer ω′2 is more favorable than the first quantity ω3={procurement price: 125 yen, procurement quantity: 4} to be offered next, the information processing apparatus 1B accepts the counter offer ω′2. This means a successful negotiation.

Next, if the negotiation is successful, the information processing apparatus 1B presents the second quantity p={sales price: 500 yen} to a buyer. In the operation example illustrated in FIG. 7, it is assumed that the buyer who has confirmed the sales price purchases three products.

Note that the second quantity p={sales price: 500 yen} is presented to the buyer using, for example, a screen displayed on a terminal device operated by the buyer. An example of a screen displayed on the terminal device operated by the buyer is illustrated in FIG. 10.

Finally, the information processing apparatus 1B observes a negotiation result. Then, the information processing apparatus 1B stores the observed negotiation result={success} in the memory of the information processing apparatus 1B as the first training data D1 in association with the first quantity sequence π={ω1={procurement price: 110 yen, procurement quantity: 5}, ω2={procurement price: 110 yen, procurement quantity: 5}, ω3={procurement price: 125 yen, procurement quantity: 4}}. FIG. 11 illustrates an example of the first training data D1 stored in the memory of the information processing apparatus 1B.

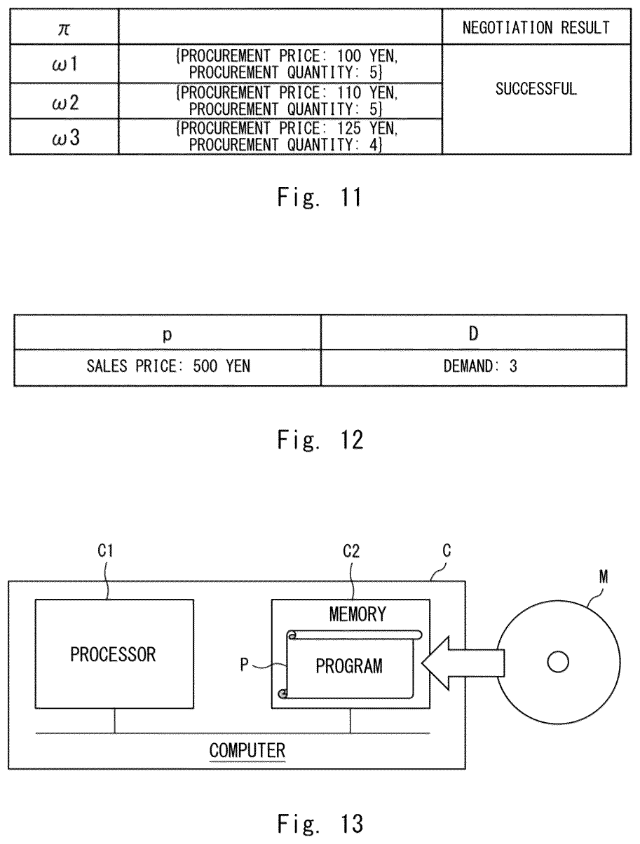

The information processing apparatus 1B observes the third quantity D. Then, the information processing apparatus 1B stores the observed third quantity D={demand: 3} in association with the second quantity p={sales price: 500 yen} in the memory as second training data D2. FIG. 12 illustrates an example of the second training data D2 stored in the memory of the information processing apparatus 1B.

### OTHER APPLICATION EXAMPLES

In the present example embodiment, the case where negotiation with the second user U2 who is a supplier and regarding a procurement price and a procurement quantity of a product and presentation of a sales price of a product to the third user U3 who is a buyer are performed from the standpoint of the first user U1 who is a seller has been considered, but the scope of application of the present disclosure is not limited thereto.

For example, the present disclosure can also be applied to a case where negotiation with the second user U2 who is an airline cargo company and regarding a loading price and the loading quantity of a cargo and presentation of a shipping cost of the cargo to the third user U3 who is a consignor are performed from the standpoint of a forwarder. In this case, each of the example embodiments described above can be applied by (1) replacing a procurement price of a product with a loading price of a cargo, (2) replacing a procurement quantity of a product with a loading quantity of a cargo, (3) replacing a sales price of the product with a shipping cost of the cargo, (4) replacing a demand of the product (the number of products desired to be purchased by a buyer) with a demand of the cargo (the number of packages desired to be transported by the consignor), and (5) replacing an inventory quantity of the product with a loading amount of the cargo already secured.

In this case, in the above-described Formula (1), min(D, m(π))×p representing a revenue of the first user U1 may be replaced with D×p, and a penalty term relevant to an overbooking amount D-m(π) may be added to Formula (1). Similarly, in the above-described Formula (2), min(D, n+m(π))×p representing a revenue of the first user U1 may be replaced with D×p, and a penalty term relevant to the overbooking amount D−(n+m(π)) may be added to Formula (2). Similarly, in the above-described Formula (3), min(Dₜₛ, nₜₛ+mₜₛ(πₜₛ))×pₜₛ representing a revenue of the first user U1 may be replaced with Dₜₛ×p, and a penalty term relevant to the overbooking amount Dₜₛ−(nₜₛ+mₜₛ(πₜₛ)) may be added to Formula (3).

### [Example of Implementation by Software]

Some or all of the functions of the information processing apparatuses 1, 1A, and 1B (hereinafter also referred to as “each of the above apparatuses”) may be implemented by hardware such as an integrated circuit (IC chip) or may be implemented by software.

In the latter case, each of the above apparatuses is implemented by, for example, a computer that executes a command of a program which is software for implementing each function. An example of such a computer (hereinafter referred to as a computer C.) is illustrated in FIG. 13. FIG. 13 is a block diagram illustrating a hardware configuration of a computer C functioning as each of the above apparatuses.

The computer C includes at least one processor C1 and at least one memory C2. A program P causing the computer C to operate as each of the above apparatuses is recorded in the memory C2. In the computer C, the processor C1 reads the program P from the memory C2 and executes the program P to implement each function of each of the above apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for developing the program P during execution and temporarily storing various types of data. The computer C may further include a communication interface for transmitting and receiving data to and from another apparatus. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

The program P can be stored and provided to the computer C using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program P may be provided to the computer C using any type of transitory computer readable media. Examples of transitory computer readable media include electric signals, optical signals, and electromagnetic waves. Transitory computer readable media can provide the program P to the computer C via a wired communication line (e.g. electric wires, and optical fibers) or a wireless communication line.

Each of the above functions of each of the above apparatuses may be implemented by one processor provided in one computer, may be implemented in cooperation with a plurality of processors provided in one computer, or may be implemented in cooperation with a plurality of processors provided in a plurality of computers, respectively. The program causing each of the above apparatuses to implement each of the above functions may be stored in one memory provided in one computer, may be stored in a distributed manner in a plurality of memories provided in one computer, or may be stored in a distributed manner in a plurality of memories provided in a plurality of computers, respectively.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### [Supplementary Notes A]

The whole or part of the example embodiments disclosed above can be described as the following supplementary notes. However, the present disclosure is not limited to the techniques described in the following supplementary note, and various modifications can be made within the scope described in the claims.

### (Supplementary Note A1)

An information processing apparatus including:
a calculation means for calculating an optimum value sequence of a first quantity sequence including first quantities sequentially presented by a first user to a second user in negotiation, and an optimum value of a second quantity presented by the first user to a third user in a case where the negotiation is successful, using an objective function representing a profit or a loss of the first user in the negotiation;
a first presentation means for sequentially presenting optimum values of the first quantities included in the optimum value sequence of the first quantity sequence calculated by the calculation means to the second user in the negotiation; and
a second presentation means for presenting the optimum value of the second quantity calculated by the calculation means to the third user in a case where the negotiation is successful.

### (Supplementary Note A2)

The information processing apparatus according to Supplementary Note A1, further including:
a first acquisition means for acquiring a first model for estimating a success probability of the negotiation from the first quantity sequence; and
a second acquisition means for acquiring a second model for estimating a probability that a reaction of the third user is obtained from a third quantity representing the reaction, wherein
the objective function includes the first, second, and third quantities as variables, and
the calculation means calculates a value sequence of the first quantity sequence and a value of the second quantity for maximizing or minimizing a value of the objective function as an optimum value sequence of the first quantity sequence and an optimum value of the second quantity using the first and second models.

### (Supplementary Note A3)

The information processing apparatus according to Supplementary Note A1, further including:
a first observation means for observing success or failure of the negotiation in a case where the optimum value sequence of the first quantity sequence calculated by the calculation means is sequentially presented to the second user;
a first update means for updating a first model for estimating a success probability of the negotiation from the first quantity sequence using a combination of the optimum value sequence of the first quantity sequence calculated by the calculation means and success or failure of the negotiation observed by the first observation means; and
a second observation means for observing a value of a third quantity representing a reaction of the third user; and
a second update means for updating a second model for estimating a probability that the reaction is obtained from the third quantity using the third quantity observed by the second observation means, wherein
the objective function includes the first, second, and third quantities as variables, and
the calculation means calculates a value sequence of the first quantity sequence and a value of the second quantity for maximizing or minimizing a value of the objective function as an optimum value sequence of the first quantity sequence and an optimum value of the second quantity using the first and second models.

### (Supplementary Note A4)

The information processing apparatus according to Supplementary Note A2 or A3, wherein
the first user is a seller who sells a product,
the second user is a supplier that supplies the product,
the third user is a buyer who buys the product,
the first quantity is a procurement price of the product and a procurement amount of the product,
the second quantity is a sales price of the product, and
the third quantity is a demand of the product.

### (Supplementary Note A5)

The information processing apparatus according to Supplementary Note A2 or A3, wherein
one or both of the first and second models have time dependency, and
the objective function is a function representing a profit or a loss of the first user in the negotiation performed at each time, and is a sum of functions including the first, second, and third quantities as variables.

### (Supplementary Note A6)

The information processing apparatus according to Supplementary Note A5, wherein
the function includes the first, second, and third quantities, and a fourth quantity as variables,
the first user is a seller who sells a product,
the second user is a supplier that supplies the product,
the third user is a buyer who buys the product,
the first quantity is a procurement price of the product and a procurement amount of the product,
the second quantity is a sales price of the product,
the third quantity is a demand of the product, and
the fourth quantity is an inventory quantity of the product.

### (Supplementary Note A7)

The information processing apparatus according to any one of Supplementary Notes A2 to A6, wherein one or both of the first and second models are models constructed by machine learning.

### [Supplementary Notes B]

The whole or part of the example embodiments disclosed above can be described as the following supplementary notes. However, the present disclosure is not limited to the techniques described in the following supplementary note, and various modifications can be made within the scope described in the claims.

### (Supplementary Note B1)

An information processing method including:
a calculation process of, by at least one processor, calculating an optimum value sequence of a first quantity sequence including first quantities sequentially presented by a first user to a second user in negotiation, and an optimum value of a second quantity presented by the first user to a third user in a case where the negotiation is successful, using an objective function representing a profit or a loss of the first user in the negotiation;
a first presentation process of sequentially presenting, by the at least one processor, optimum values of the first quantities included in the optimum value sequence of the first quantity sequence calculated in the calculation process to the second user in the negotiation; and
a second presentation process of presenting, by the at least one processor, the optimum value of the second quantity calculated in the calculation process to the third user in a case where the negotiation is successful.

### (Supplementary Note B2)

The information processing method according to Supplementary Note B1, further including:
a first acquisition process of acquiring, by the at least one processor, a first model for estimating a success probability of the negotiation from the first quantity sequence; and
a second acquisition process of acquiring, by the at least one processor, a second model for estimating, by the at least one processor, a probability that a reaction of the third user is obtained from a third quantity representing the reaction, wherein
the objective function includes the first, second, and third quantities as variables, and
in the calculation process, the at least one processor calculates a value sequence of the first quantity sequence and a value of the second quantity for maximizing or minimizing a value of the objective function as an optimum value sequence of the first quantity sequence and an optimum value of the second quantity using the first and second models.

### (Supplementary Note B3)

The information processing method according to Supplementary Note B1, further including:
a first observation process of observing, by the at least one processor, success or failure of the negotiation in a case where the optimum value sequence of the first quantity sequence calculated in the calculation process is sequentially presented to the second user;
a first update process of updating, by the at least one processor, a first model for estimating a success probability of the negotiation from the first quantity sequence using a combination of the optimum value sequence of the first quantity sequence calculated in the calculation process and success or failure of the negotiation observed in the first observation process;
a second observation process of observing, by the at least one processor, a value of a third quantity representing a reaction of the third user; and
a second update process of updating, by the at least one processor, a second model for estimating a probability that the reaction is obtained from the third quantity using the third quantity observed in the second observation process, wherein
the objective function includes the first, second, and third quantities as variables, and
in the calculation process, the at least one processor calculates a value sequence of the first quantity sequence and a value of the second quantity for maximizing or minimizing a value of the objective function as an optimum value sequence of the first quantity sequence and an optimum value of the second quantity using the first and second models.

### (Supplementary Note B4)

The information processing method according to Supplementary Note B2 or B3, wherein
the first user is a seller who sells a product,
the second user is a supplier that supplies the product,
the third user is a buyer who buys the product,
the first quantity is a procurement price of the product and a procurement amount of the product,
the second quantity is a sales price of the product, and
the third quantity is a demand of the product.

### (Supplementary Note B5)

The information processing method according to Supplementary Note B2 or B3, wherein
one or both of the first and second models have time dependency, and
the objective function is a function representing a profit or a loss of the first user in the negotiation performed at each time, and is a sum of functions including the first, second, and third quantities as variables.

### (Supplementary Note B6)

The information processing method according to Supplementary Note B5, wherein
the function includes the first, second, and third quantities, and a fourth quantity as variables,
the first user is a seller who sells a product,
the second user is a supplier that supplies the product,
the third user is a buyer who buys the product,
the first quantity is a procurement price of the product and a procurement amount of the product,
the second quantity is a sales price of the product,
the third quantity is a demand of the product, and
the fourth quantity is an inventory quantity of the product.

### (Supplementary Note B7)

The information processing method according to any one of Supplementary Notes B2 to B6, wherein one or both of the first and second models are models constructed by machine learning.

### [Supplementary Notes C]

The whole or part of the example embodiments disclosed above can be described as the following supplementary notes. However, the present disclosure is not limited to the techniques described in the following supplementary note, and various modifications can be made within the scope described in the claims.

### (Supplementary Note C1)

An information processing program causing a processor to execute:
a calculation process of calculating an optimum value sequence of a first quantity sequence including first quantities sequentially presented by a first user to a second user in negotiation, and an optimum value of a second quantity presented by the first user to a third user in a case where the negotiation is successful, using an objective function representing a profit or a loss of the first user in the negotiation;
a first presentation process of sequentially presenting optimum values of the first quantities included in the optimum value sequence of the first quantity sequence calculated in the calculation process to the second user in the negotiation; and
a second presentation process of presenting the optimum value of the second quantity calculated in the calculation process to the third user in a case where the negotiation is successful.

### (Supplementary Note C2)

The information processing program according to Supplementary Note C1, further causing the process to execute:
a first acquisition process of acquiring a first model for estimating a success probability of the negotiation from the first quantity sequence; and
a second acquisition process of acquiring a second model for estimating a probability that a reaction of the third user is obtained from a third quantity representing the reaction, wherein
the objective function includes the first, second, and third quantities as variables, and
in the calculation process, a value sequence of the first quantity sequence and a value of the second quantity for maximizing or minimizing a value of the objective function are calculated as an optimum value sequence of the first quantity sequence and an optimum value of the second quantity using the first and second models.

### (Supplementary Note C3)

The information processing program according to Supplementary Note C1, further causing the process to execute:
a first observation process of observing success or failure of the negotiation in a case where the optimum value sequence of the first quantity sequence calculated in the calculation process is sequentially presented to the second user;
a first update process of updating a first model for estimating a success probability of the negotiation from the first quantity sequence using a combination of the optimum value sequence of the first quantity sequence calculated in the calculation process and success or failure of the negotiation observed in the first observation process;
a second observation process of observing a value of a third quantity representing a reaction of the third user; and
a second update process of updating a second model for estimating a probability that the reaction is obtained from the third quantity using the third quantity observed in the second observation process, wherein
the objective function includes the first, second, and third quantities as variables, and
in the calculation process, a value sequence of the first quantity sequence and a value of the second quantity for maximizing or minimizing a value of the objective function are calculated as an optimum value sequence of the first quantity sequence and an optimum value of the second quantity using the first and second models.

### (Supplementary Note C4)

The information processing program according to Supplementary Note C2 or C3, wherein
the first user is a seller who sells a product,
the second user is a supplier that supplies the product,
the third user is a buyer who buys the product,
the first quantity is a procurement price of the product and a procurement amount of the product,
the second quantity is a sales price of the product, and
the third quantity is a demand of the product.

### (Supplementary Note C5)

The information processing program according to Supplementary Note C2 or C3, wherein
one or both of the first and second models have time dependency, and
the objective function is a function representing a profit or a loss of the first user in the negotiation performed at each time, and is a sum of functions including the first, second, and third quantities as variables.

### (Supplementary Note C6)

The information processing program according to Supplementary Note C5, wherein
the function includes the first, second, and third quantities, and a fourth quantity as variables,
the first user is a seller who sells a product,
the second user is a supplier that supplies the product,
the third user is a buyer who buys the product,
the first quantity is a procurement price of the product and a procurement amount of the product,
the second quantity is a sales price of the product,
the third quantity is a demand of the product, and
the fourth quantity is an inventory quantity of the product.

### (Supplementary Note C7)

The information processing program according to any one of Supplementary Notes C2 to C6, wherein one or both of the first and second models are models constructed by machine learning.

### [Supplementary Notes D]

The whole or part of the example embodiments disclosed above can be described as the following supplementary notes. However, the present disclosure is not limited to the techniques described in the following supplementary note, and various modifications can be made within the scope described in the claims.

### (Supplementary Note D1)

An information processing apparatus including at least one processor, wherein the at least one processor executes
a calculation process of calculating an optimum value sequence of a first quantity sequence including first quantities sequentially presented by a first user to a second user in negotiation, and an optimum value of a second quantity presented by the first user to a third user in a case where the negotiation is successful, using an objective function representing a profit or a loss of the first user in the negotiation;
a first presentation process of sequentially presenting optimum values of the first quantities included in the optimum value sequence of the first quantity sequence calculated in the calculation process to the second user in the negotiation; and
a second presentation process of presenting the optimum value of the second quantity calculated in the calculation process to the third user in a case where the negotiation is successful.

The information processing apparatus may further include a memory. The memory may store a program causing the at least one processor to execute each of the processes.

### (Supplementary Note D2)

The information processing apparatus according to Supplementary Note D1, wherein the at least one processor further executes
a first acquisition process of acquiring a first model for estimating a success probability of the negotiation from the first quantity sequence; and
a second acquisition process of acquiring a second model for estimating a probability that a reaction of the third user is obtained from a third quantity representing the reaction, wherein
the objective function includes the first, second, and third quantities as variables, and
in the calculation process, the at least one processor calculates a value sequence of the first quantity sequence and a value of the second quantity for maximizing or minimizing a value of the objective function as an optimum value sequence of the first quantity sequence and an optimum value of the second quantity using the first and second models.

### (Supplementary Note D3)

The information processing apparatus according to Supplementary Note D1, wherein the at least one processor further executes
a first observation process of observing success or failure of the negotiation in a case where the optimum value sequence of the first quantity sequence calculated in the calculation process is sequentially presented to the second user;
a first update process of updating a first model for estimating a success probability of the negotiation from the first quantity sequence using a combination of the optimum value sequence of the first quantity sequence calculated in the calculation process and success or failure of the negotiation observed in the first observation process;
a second observation process of observing a value of a third quantity representing a reaction of the third user; and
a second update process of updating a second model for estimating a probability that the reaction is obtained from the third quantity using the third quantity observed in the second observation process,
the objective function includes the first, second, and third quantities as variables, and
in the calculation process, the at least one processor calculates a value sequence of the first quantity sequence and a value of the second quantity for maximizing or minimizing a value of the objective function as an optimum value sequence of the first quantity sequence and an optimum value of the second quantity using the first and second models.

### (Supplementary Note D4)

The information processing apparatus according to Supplementary Note D2 or D3, wherein
the first user is a seller who sells a product,
the second user is a supplier that supplies the product,
the third user is a buyer who buys the product,
the first quantity is a procurement price of the product and a procurement amount of the product,
the second quantity is a sales price of the product, and
the third quantity is a demand of the product.

### (Supplementary Note D5)

The information processing apparatus according to Supplementary Note D2 or D3, wherein
one or both of the first and second models have time dependency, and
the objective function is a function representing a profit or a loss of the first user in the negotiation performed at each time, and is a sum of functions including the first, second, and third quantities as variables.

### (Supplementary Note D6)

The information processing apparatus according to Supplementary Note D5, wherein
the function includes the first, second, and third quantities, and a fourth quantity as variables,
the first user is a seller who sells a product,
the second user is a supplier that supplies the product,
the third user is a buyer who buys the product,
the first quantity is a procurement price of the product and a procurement amount of the product,
the second quantity is a sales price of the product,
the third quantity is a demand of the product, and
the fourth quantity is an inventory quantity of the product.

### (Supplementary Note D7)

The information processing apparatus according to any one of Supplementary Notes D2 to D6, wherein one or both of the first and second models are models constructed by machine learning.

### [Supplementary Notes E]

The whole or part of the example embodiments disclosed above can be described as the following supplementary note. However, the present disclosure is not limited to the techniques described in the following supplementary note, and various modifications can be made within the scope described in the claims.

### (Supplementary Note E1)

A non-transitory computer-readable medium storing a program that causes a computer to execute:
a calculation process of calculating an optimum value sequence of a first quantity sequence including first quantities sequentially presented by a first user to a second user in negotiation, and an optimum value of a second quantity presented by the first user to a third user in a case where the negotiation is successful, using an objective function representing a profit or a loss of the first user in the negotiation;
a first presentation process of sequentially presenting optimum values of the first quantities included in the optimum value sequence of the first quantity sequence calculated in the calculation process to the second user in the negotiation; and
a second presentation process of presenting the optimum value of the second quantity calculated in the calculation process to the third user in a case where the negotiation is successful.

Some or all of elements (e.g., structures and functions) specified in Supplementary Notes A2 to A7 dependent on Supplementary Note A1 may also be dependent on Supplementary Note E1 in dependency similar to that of Supplementary Notes A2 to A7 on Supplementary Note A1. Some or all of elements specified in any of Supplementary Notes may be applied to various types of hardware, software, and recording means for recording software, systems, and methods.

What is claimed is:

1. An information processing apparatus comprising:
at least one memory storing instructions, and
at least one processor configured to execute the instructions to;
calculate an optimum value sequence of a first quantity sequence including first quantities sequentially presented by a first user to a second user in negotiation, and an optimum value of a second quantity presented by the first user to a third user in a case where the negotiation is successful, using an objective function representing a profit or a loss of the first user in the negotiation;
sequentially present optimum values of the first quantities included in the optimum value sequence of the first quantity sequence to the second user in the negotiation; and
present the optimum value of the second quantity to the third user in a case where the negotiation is successful.

2. The information processing apparatus according to claim 1, wherein the at least one processor is further configured to execute the instructions to:
acquire a first model for estimating a success probability of the negotiation from the first quantity sequence; and
acquire a second model for estimating a probability that a reaction of the third user is obtained from a third quantity representing the reaction, wherein
the objective function includes the first, second, and third quantities as variables, and
calculate a value sequence of the first quantity sequence and a value of the second quantity for maximizing or minimizing a value of the objective function as an optimum value sequence of the first quantity sequence and an optimum value of the second quantity using the first and second models.

3. The information processing apparatus according to claim 1, wherein the at least one processor is further configured to execute the instructions to:
observe success or failure of the negotiation in a case where the optimum value sequence of the first quantity sequence is sequentially presented to the second user;
update a first model for estimating a success probability of the negotiation from the first quantity sequence using a combination of the optimum value sequence of the first quantity sequence and success or failure of the negotiation;
observe a value of a third quantity representing a reaction of the third user; and
update a second model for estimating a probability that the reaction is obtained from the third quantity, wherein
the objective function includes the first, second, and third quantities as variables, and
calculate a value sequence of the first quantity sequence and a value of the second quantity for maximizing or minimizing a value of the objective function as an optimum value sequence of the first quantity sequence and an optimum value of the second quantity using the first and second models.

4. The information processing apparatus according to claim 2, wherein
the first user is a seller who sells a product,
the second user is a supplier that supplies the product,
the third user is a buyer who buys the product,
the first quantity is a procurement price of the product and a procurement amount of the product,
the second quantity is a sales price of the product, and
the third quantity is a demand of the product.

5. The information processing apparatus according to claim 2, wherein
one or both of the first and second models have time dependency, and
the objective function is a function representing a profit or a loss of the first user in the negotiation performed at each time, and is a sum of functions including the first, second, and third quantities as variables.

6. The information processing apparatus according to claim 5, wherein
the function includes the first, second, and third quantities, and a fourth quantity as variables,
the first user is a seller who sells a product,
the second user is a supplier that supplies the product,
the third user is a buyer who buys the product,
the first quantity is a procurement price of the product and a procurement amount of the product,
the second quantity is a sales price of the product,
the third quantity is a demand of the product, and
the fourth quantity is an inventory quantity of the product.

7. The information processing apparatus according to claim 2, wherein one or both of the first and second models are models constructed by machine learning.

8. An information processing method comprising:
a calculation process of, by a processor, calculating an optimum value sequence of a first quantity sequence including first quantities sequentially presented by a first user to a second user in negotiation, and an optimum value of a second quantity presented by the first user to a third user in a case where the negotiation is successful, using an objective function representing a profit or a loss of the first user in the negotiation;
a first presentation process of sequentially presenting, by the processor, optimum values of the first quantities included in the optimum value sequence of the first quantity sequence calculated in the calculation process to the second user in the negotiation; and
a second presentation process of presenting, by the processor, the optimum value of the second quantity calculated in the calculation process to the third user in a case where the negotiation is successful.

9. A non-transitory computer-readable medium storing a program that causes a computer to execute:
a calculation process of calculating an optimum value sequence of a first quantity sequence including first quantities sequentially presented by a first user to a second user in negotiation, and an optimum value of a second quantity presented by the first user to a third user in a case where the negotiation is successful, using an objective function representing a profit or a loss of the first user in the negotiation;
a first presentation process of sequentially presenting optimum values of the first quantities included in the optimum value sequence of the first quantity sequence calculated in the calculation process to the second user in the negotiation; and
a second presentation process of presenting the optimum value of the second quantity calculated in the calculation process to the third user in a case where the negotiation is successful.
